(19) United States
(12) Patent Application Publication
(10) Pub. No.: US 2002/0001147 A1
(43) Pub. Date: Jan. 3, 2002

(54) ANTI-THEFT DEVICE FOR EXTERIORLY MOUNTED REAR-VIEW VEHICULAR MIRROR

(76) Inventor: ALEXANDER ZAPADINSKY, BROOKLYN, NY (US)

Correspondence Address: BIERMAN MUSERLIAN AND LUCAS, 600 THIRD AVENUE, NEW YORK, NY, 10016

(21) Appl. No.: 09/348,066

(22) Filed: Jul. 6, 1999

(51) Int. Cl. G02B 5/08

(52) U.S. Cl. 359/838

(57) ABSTRACT

The device comprising a lip which is affixed to the shell of the rear-view mirror, overlaps and surrounds the edge of the mirror plate and prevents access to the mirror plate while not interfering with the view provided by the mirror plate to the driver of the vehicle. The lip is part of a security bracket that is attached to the shell, and is formed as part of a second shell that fits over the original shell or is formed as part of the original shell.

### BACKGROUND OF THE INVENTION

1. Field of the Invention

This Invention relates to externally mounted rear-view mirrors which are used on vehicles and, more specifically, to an anti-theft device which is attached to an externally mounted rear-view mirror to prevent the mirror plate or mirror glass from being stolen.

2. Art Related to the Invention

Externally mounted rear-view mirrors, often referred to as side-view mirrors, are mounted on the outside of a vehicle to allow the driver to see traffic approaching from behind. Typically, such mirrors are mounted on the driver's side of the vehicle and often times on the passenger side of the vehicle. A typical externally mounted rear view mirror, which is mounted on the driver's side of a vehicle, is shown in FIG. 1.

Referring to FIG. 1, vehicle 10 has a rear-view mirror 12 mounted along a side wall of the vehicle on the driver's side. Rear-view mirror 12 comprises a shell 14 in which a mirror plate or mirror glass 16 has been mounted. Mirror plate 16 is typically attached to motor 18 by means of an adhesive to bracket 19 which in turn mounts on motor 18, see FIG. 4. Motor 18 allows for the adjustment of the angle of mirror plate 16 from inside the vehicle. Often times, motor 18 is an electrical motor, however, it is not uncommon for motor 18 to be a mechanical gear assembly which is operated from inside the vehicle and allows for adjustment of mirror plate 16 via a handle which extends into the vehicle.

Shell 14 has a base 20 which is attached to the side of the vehicle and through which electrical wires and/or a gear handle travels and passes into the vehicle. Shell 14 defines a hollow 22 which has a rim 24, see FIG. 4. Rim 24, in some instances, curves downward and ends in the same plane as the edge of mirror 16 (see FIG. 9). Other times, rim 24 does not curve at all but extends horizontally towards the back of the vehicle, see FIG. 1.

The theft of auto parts is well known. Typically, thieves steel various parts off automobiles, or the whole automobile, and strip it down into its various parts. Such theft occurs because it is fairly well known that auto parts can be fairly expensive and the sale of the parts is lucrative enough to support its own industry. One of the auto parts that have recently come under a high degree of theft is mirror plate, such as mirror plate 16 shown in the drawings.

There is a need for a security device, which can prevent the theft of mirror plates.

### SUMMARY OF THE INVENTION

Applicant has learned that one of the primary methods for stealing mirror plates from externally mounted rear-view mirrors employs the step of passing a flat tool between the rim of the shell of the rear-view mirror and the edge of the mirror plate and then prying the mirror plate from the bracket. The adhesive forces between the mirror plate and the bracket are not strong enough to prevent the separation of the mirror plate from the bracket.

Applicant has further discovered that an anti-theft device which has a lip that is affixed to the shell of the rear-view mirror and overlaps the edge of the mirror plate can be used to prevent theft of a mirror plate from a rear-view mirror. The lip, according to the present Invention, is attached to the shell of the rear-view mirror by means of: a bracket; is a pre-formed second shell which fits over the original shell in whole or in part; or is pre-formed with the original shell of the rear-view mirror. The lip extends beyond the rim of a shell and overlaps the edge of the mirror plate, substantially surrounding the edge of the mirror plate. Applicant has found that, a thief is foiled from using an instrument to pull off or pry off the mirror plate when the rear-view mirror employs the anti-theft device of the present invention.

The anti-theft device according to the present Invention can either be formed as an integral part of the shell; as a second shell that fits over the first shell; or as a separate security bracket that is secured to the shell. The security bracket can be mounted directly to the exterior of the shell of the rear view mirror; or it can be mounted to a security insert, which is mounted inside the shell. The security bracket can be mounted directly to the shell in a conventional manner such as a rivet or a screw; or the shell and security bracket can be preformed to have a tongue and groove arrangement which allows the two to be snapped together in a conventional manner.

Applicant has also learned that the anti-theft device of the present Invention can be made such that it is aesthetically pleasing and does not detract from the overall appearance of the externally mounted rear-view mirror.

Preferably, rubber housing is employed with the security bracket of the present Invention when a rivet or screw is used to attach the bracket to the shell or the security insert. The rubber housing covers the head of the rivet or screw and adds to both security and the aesthetic nature of the present invention.

These, and other aspects of the present Invention, may be more fully listed by reference to one or more of the following drawings.

### BRIEF DESCRIPTION OF THE DRAWINGS

FIG. 1 is a partial view of the side of an automobile with a conventional rear-view mirror mounted thereon;

FIG. 2 is a frontal view of the security insert for use in the present Invention;

FIG. 3 is a view of the security insert of FIG. 2 which has been bent to fit inside the rear view-mirror;

FIG. 4 is an exploded view of the separate security bracket and security insert of the present Invention in conjunction with the shell of a rear-view mirror;

FIG. 5 is a view of the rear-view mirror of FIG. 4 in assembled form;

FIG. 6 is a partial sectional view taken along lines 6-6 of FIG. 5;

FIG. 7 is an exploded view of the separate security bracket of the present Invention, which is to be mounted externally to a rear-view mirror;

FIG. 8 is a view of the device of the present Invention as shown in FIG. 7 in assembled form;

FIG. 9 is a sectional view taken along line 9-9 of FIG. 8;

FIG. 10 is an exploded view of the security bracket of the present invention wherein the shell has been molded to accept the security bracket;

FIG. 11 is a view of the assembled mirror of FIG. 10;

FIG. 12 is a sectional view taken along line 12-12 of FIG. 11;

FIG. 13 is a view of the present invention wherein the anti-theft device has been pre-formed with the shell;

FIG. 14 is a sectional view taken along line 14-14 of FIG. 13;

FIG. 15 is a view of the anti-theft device of the present Invention which is a second shell mounted to The original mirror shell;

FIG. 16 is a sectional view taken along line 16-16 of FIG. 15; and

FIG. 17 illustrates a rubber housing employed with the present Invention.

### DETAILED DESCRIPTION OF THE INVENTION

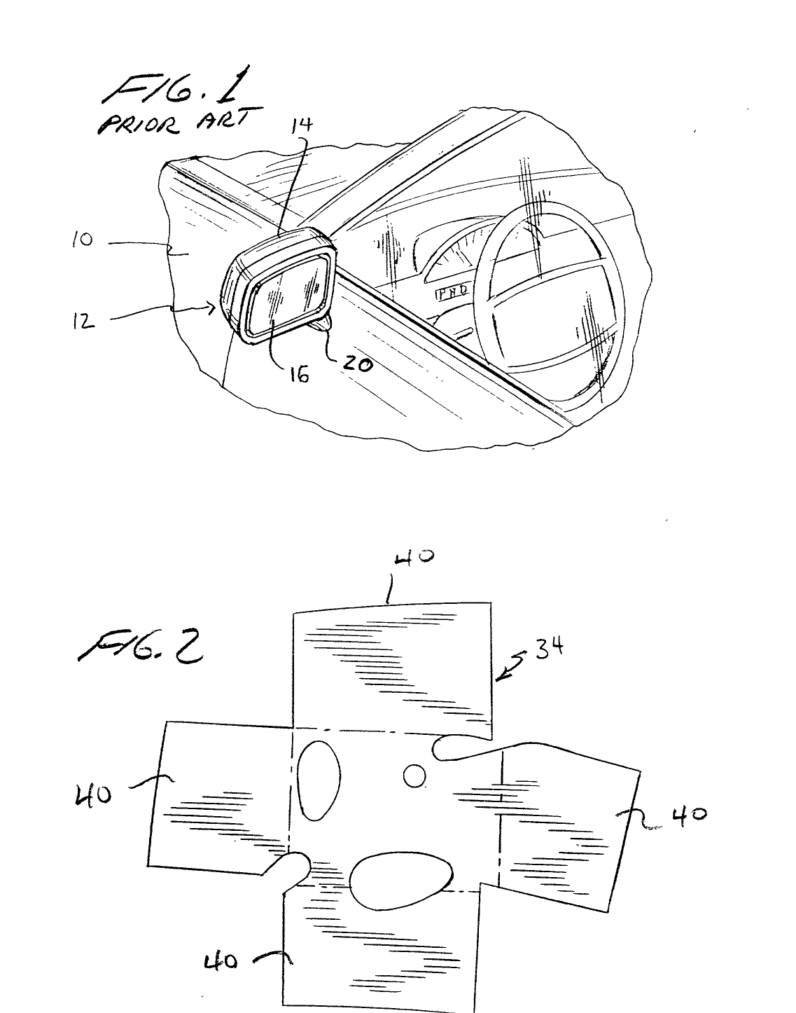

Referring now to the Figures, FIG. 1 shows vehicle 10 with rear-view mirror 12 attached thereto. Rear-view mirror 12 comprises shell 14 and mirror plate 16. As shown in FIG. 3, inside of shell 14 is a motor 18. Mirror plate 16 is attached by an adhesive to bracket 19 which in turn attaches to motor 18 as shown. Motor 18 allows for adjustment of the angle of mirror plate 16 by the driver of vehicle 10 from inside the vehicle. Shell 14 defines a hollow 22 in which motor 18 is housed. Hollow 22 ends at rim 24. Rear-view mirror 12 is attached to the side of vehicle 10 at base 20.

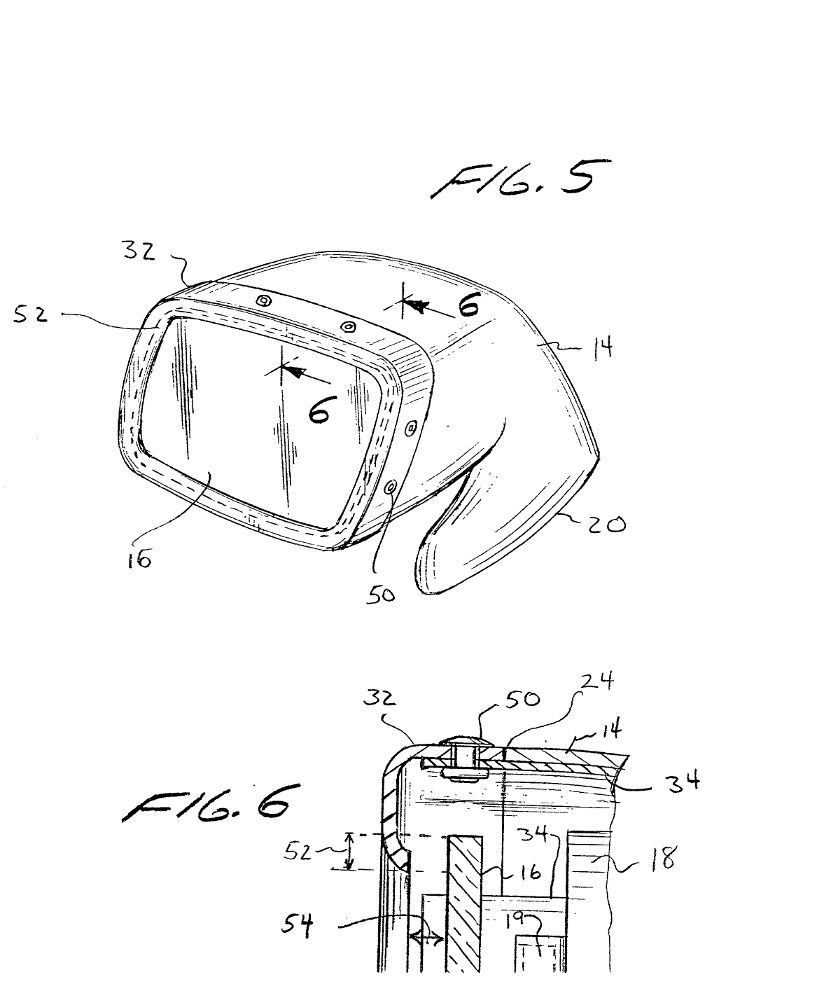

FIG. 4 illustrates one of the preferred embodiments of the anti-theft device in accordance with the present Invention. Anti-theft device 30 comprises security bracket 32 and security insert 34. Security insert 34 has holes 36 which align with holes 38 in security bracket 32 when security bracket 32 is mounted onto rear-view mirror 12 as shown in FIG. 5. In order to affix security bracket 32 to security insert 34 via holes 36 and 38, fastener 50 is employed. Fastener 50 is shown in the Figures as a conventional rivet.

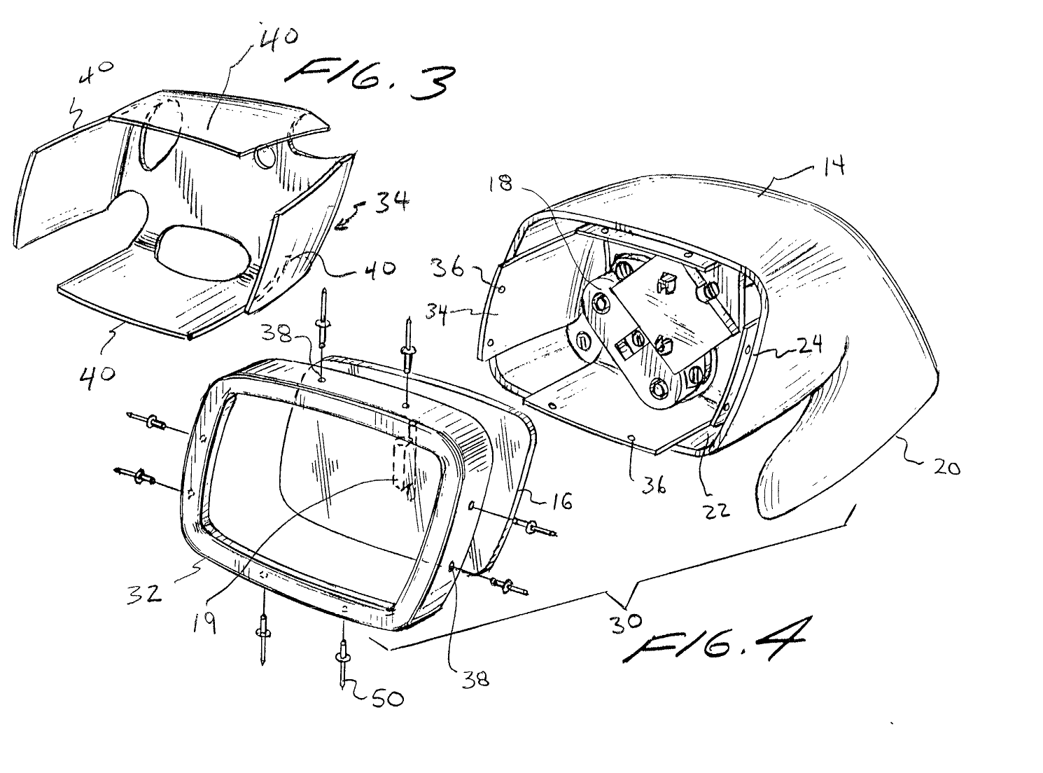

Security insert 34 is shown in a flat view in FIG. 2 and is made of sheet metal, or other similar material, so that it can be stamped out and bent as shown in FIG. 3 to allow it to be inserted into shell 14 as shown in FIG. 4. The various oblong holes which are shown in FIG. 3 in the back of security insert 34 are designed to facilitate its insert into shell 14. These oblong holes are made to accommodate motor 18.

In order to assemble the anti-theft device as shown in FIG. 4, motor 18 is removed and security insert 34 is mounted inside and securely affixed to shell 14. Then, motor 18 is remounted in shell 14. As can be seen in FIGS. 2, 3 and 4, security insert 34 has four wings 40 which extend out past rim 24. Once motor 18 has been remounted into shell 14, mirror plate 16 is reaffixed to motor 18 via bracket 19. At that point, security bracket 32 is mounted onto shell 14 such that holes 38 align with holes 36 and rivets 50 affix bracket 32 to insert 34. The final assembly can be seen in FIG. 5.

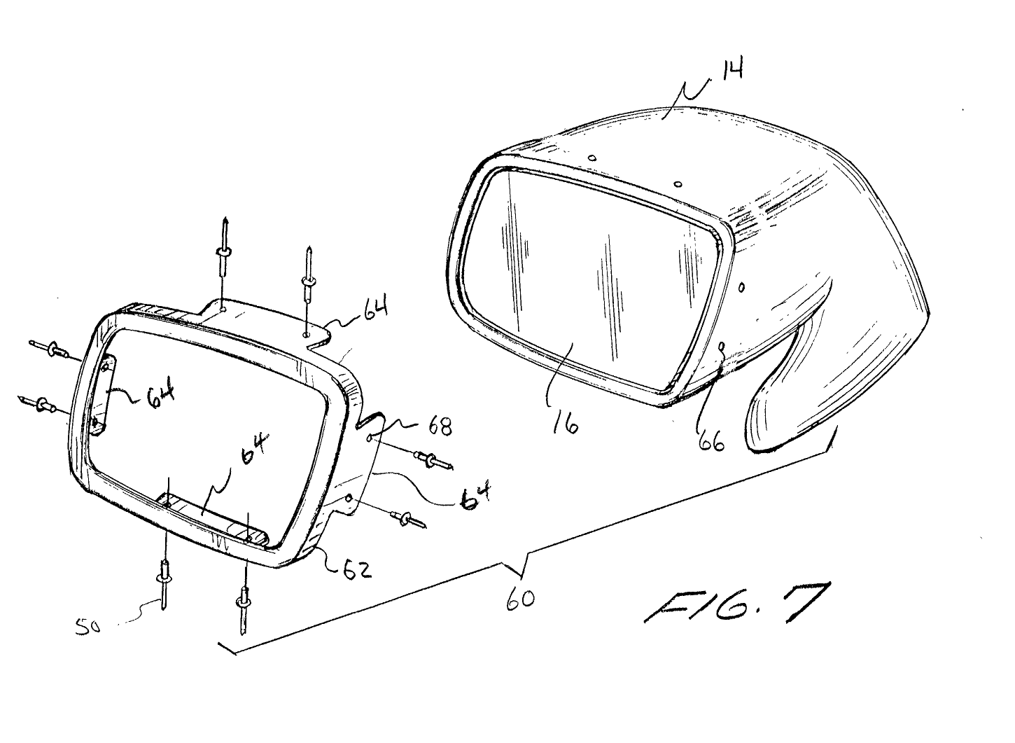

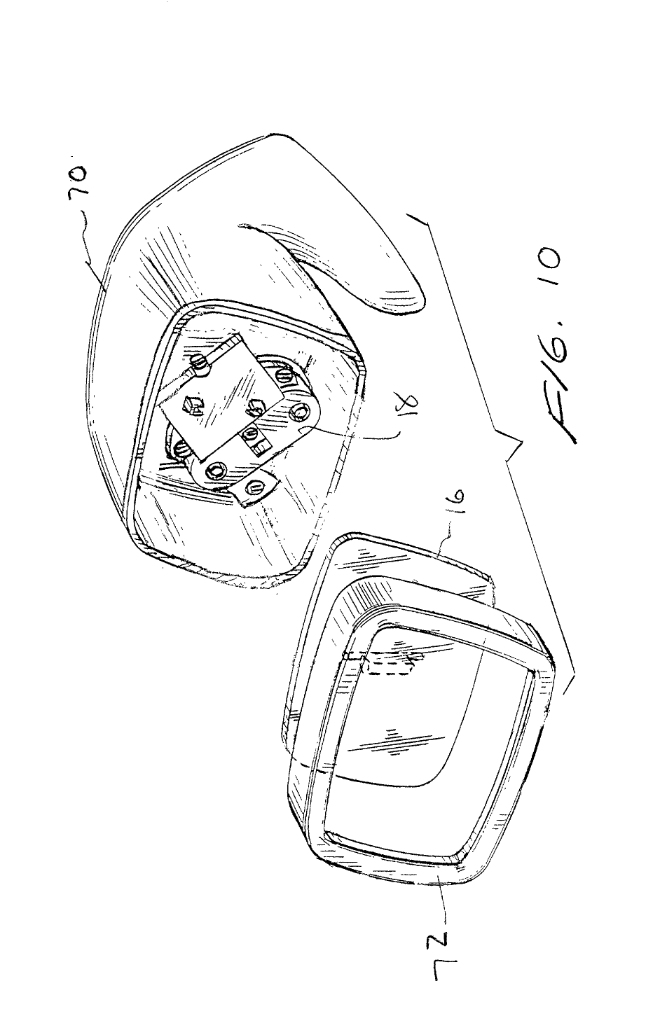

As shown in FIG. 6, security bracket 32 overlaps the edge of mirror plate 16 by a distance of 52. The overlap is critical in order to prevent the theft of mirror plate 16. The preferred overlap for the anti-theft device of the present Invention is between about 1 to about 5 millimeters and, more preferably, about 3 millimeters. This overlap which can be also seen in FIGS. 9, 12 and 14 preferably extends completely around the exterior edge of mirror plate 16 thereby preventing a thief from removing mirror plate 16 from rear view mirror 12. Minor, unsubstantial breaks or voids can occur in the overlap, however, these breaks should be small so as not to effect the anti-theft properties of the present invention.

As will be appreciated, mirror 16 pivots to allow for adjustment of mirror 16 to accommodate the driver so the driver can see what is behind and to the side of the vehicle. To do this, there must be free space 54 between mirror 16 and bracket 32. Free space 54 is preferably about 15 to 20 millimeters and more preferably about 16 millimeters. Free space 54, when mirror 16 has been pivoted to an extreme should be about 3 millimeters.

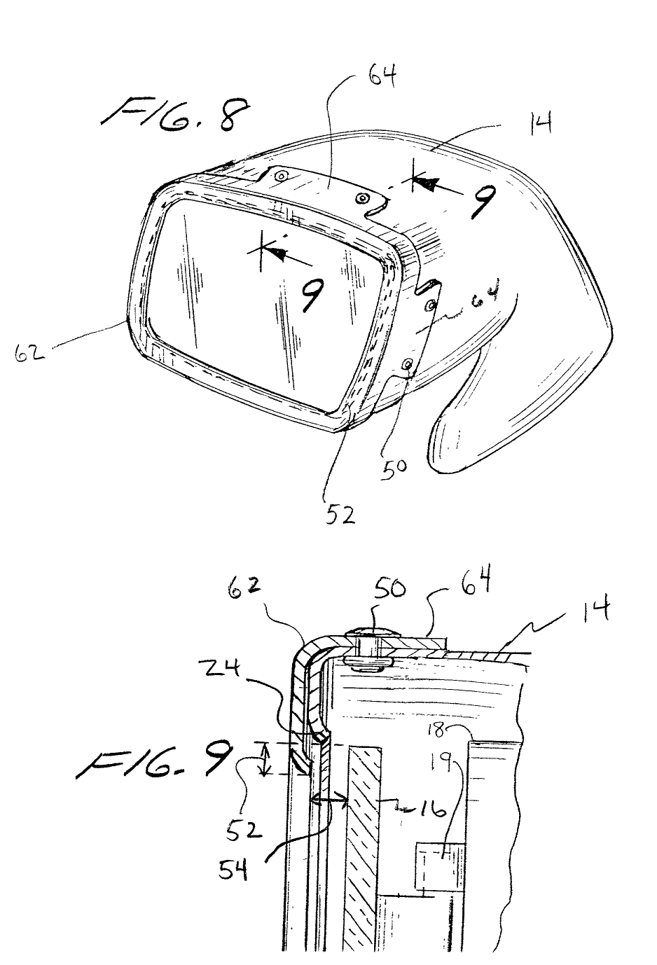

Another preferred embodiment of the present Invention is shown in FIGS. 7-9.

As shown in FIG. 7, anti-theft device 60 comprises a security bracket 62 which has wings 64 that overlap onto shell 14. In this embodiment, holes 66 are drilled into shell 14 and are positioned so that they align with holes 68 of security bracket 62. When security bracket 62 is mounted onto shell 14, holes 66 align with holes 68 and allow for fastener 50 to affix security bracket 62 onto shell 14.

The assembled unit is shown in FIG. 8. Overlap 52 extends around the edge of mirror plate 16. FIG. 9 is a sectional view showing rivet 50 attached through shell 14 and security bracket 62 with overlap 52. In FIG. 9, rim 24 of shell 14 ends contemporaneously with the edge of mirror plate 16. This is conventional in some rear-view mirror designs.

In FIGS. 7 and 8, wings 64 of security bracket 62 overlap a distance of about 1 to 3 centimeters and, more preferably, about 2 centimeters onto shell 14. Holes 66 are positioned such as they extend about 1 or 2 centimeters back on the surface of rim 24. By having holes 68 and wings 64 extend a distance back into shell 14, a secure attachment between security bracket 62 and shell 14 is obtained.

Wings 64 can extend further back on to shell 14, however for aesthetic purposes the distance they extend back should be limited. The wings can also be connected to each other for a continuous sleeve around shell 14. Extending wings 64 further back to cover a substantial portion of shell 64 and/or connecting wings 64 into a continuous sleeve would allow a changing of the color or decorating the mirror shell, this would allow an owner to customize the vehicle.

Fastener 50 has been shown in the drawings to be a conventional rivet, however, any other conventional securing element can be employed, such as, screws with star heads or other types of heads which are non-conventional and which are considered to be security-type fasteners.

Preferably, security brackets 32 and 62 are made from sheet metal which is easily stamped out to conform to the shape of the exterior of the shell and, specifically, the rim section of the shell.

Security bracket 32 and 62 are formed in a conventional manner using conventional equipment, suitable sheet metal which is first bent and then painted. It can be chemical treated and hardened to prevent it from being cut off. When it has been treated to harden, it is painted afterwards. Such steps are conventional and are conducted in a conventional manner.

As shown in FIG. 17, a rubberized housing 69 can be employed. Housing 69 is preferably about 0.8 to 3.0 millimeters thick and is made of synthetic rubber or a rubberized plastic which can be pulled back to allow for fastener 50 to be inserted. Housing 69 helps protect rivet 50 from the elements and dresses-up the over all appearance of the mirror. Housing 69 can be of different colors or the same color as shell 12.

Housing 69 is suitably made in a roll and a piece of suitable length is cut from the roll and fitted around the perimeter of the bracket.

Preferably, housing 69 extends between the bracket and the shell to allow the rivet to extend through it and hold it in place. At the other end, housing 69 extends up and over the top of rivet 50 and starts down the front of the bracket as shown in FIG. 17.

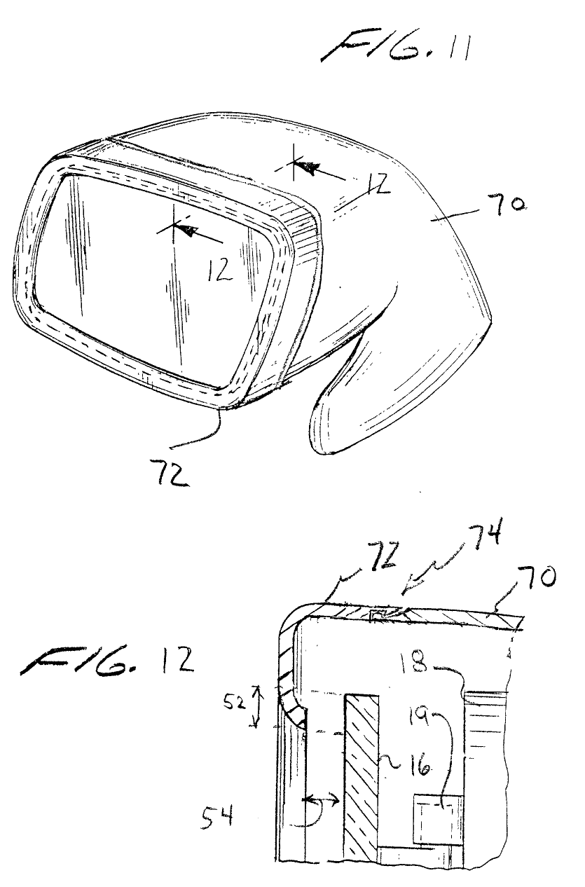

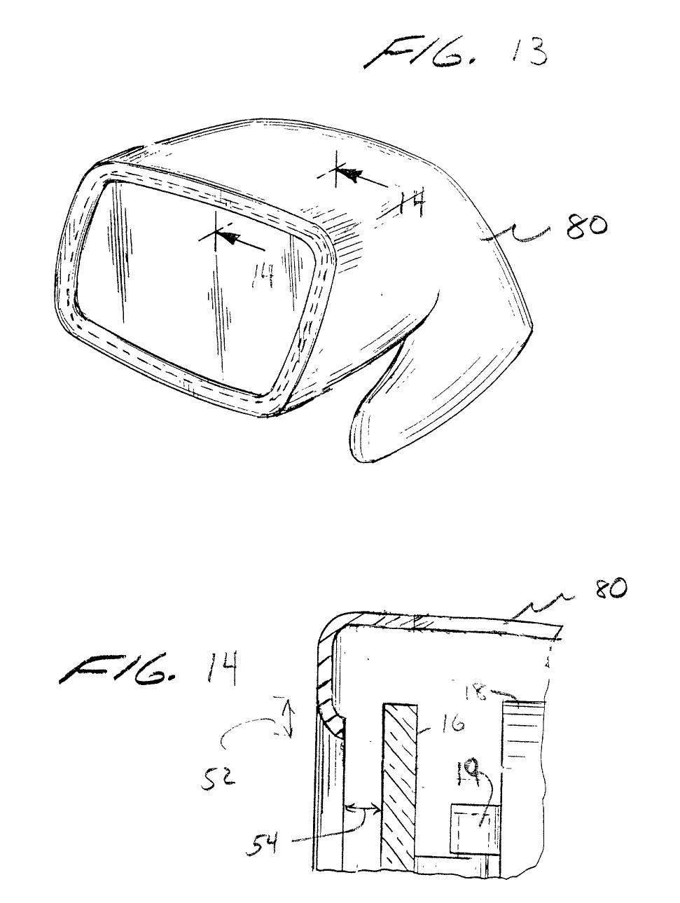

FIGS. 10-12 illustrate the anti-theft device of the present Invention wherein shell 70 and security bracket 72 have been formed with a tongue and grove like arrangement 74 which allows the two to be snapped together as shown in FIG. 12. The pressure due to the shape of the bracket 72 and shell 70 provide a secure attachment.

Shell 70 and bracket 72 are preferably molded out of plastic in a conventional manner. Any conventional tongue and groove or snap like self-sealing arrangement can be employed.

Although tongue and groove 74 in FIGS. 10-12 is illustrated at the front of shell 70, it could also be situated in the middle or back of shell 70. As will be appreciated, mirror 16 can not be attached to motor 18 when overlap 52 is present. In some way a thief can not steal the mirror from the shell when overlap 52 exists, mirror 16 can not be attached to motor 18 if the bracket has already been attached to the shell.

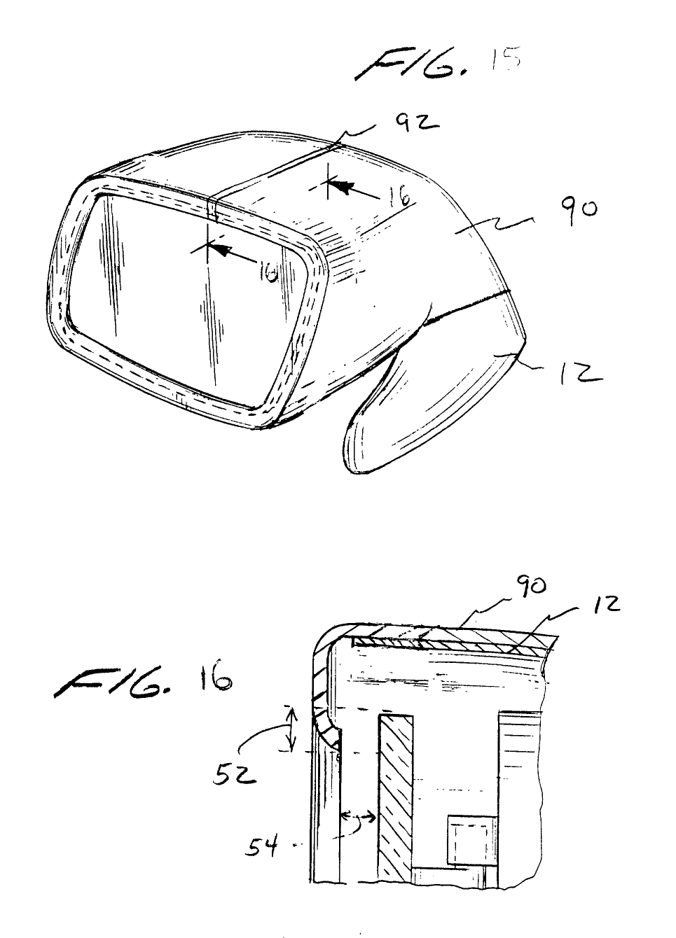

In FIGS. 13 and 14, shell 80 has been formed with overlap 52. In this arrangement, a trap door, not shown, is provided in the base of shell 80 to allow motor 18 and mirror 16 to be inserted into shell 80.

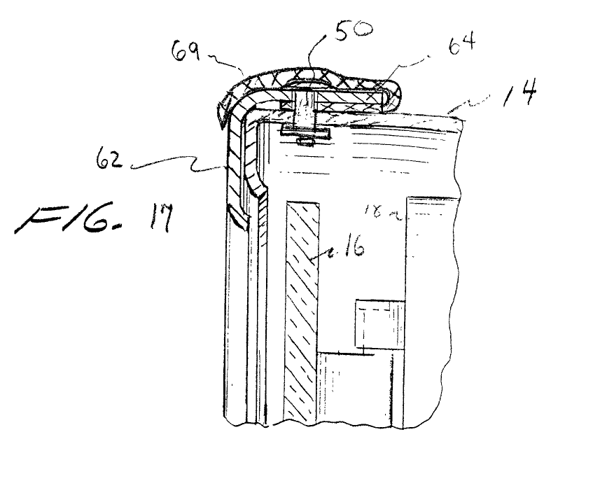

FIGS. 15 and 16 illustrate a second shell 80 which employs a tongue and groove arrangement 92 to allow it to fit into shell 14. Employing the anti-theft device in FIGS. 15 and 16, different colors on designs can be placed won second shell 90 to dress-up the appearance of the vehicle.

Shell 90 is made in a conventional manner using conventional equipment.

Suitably, the second shell is molded out of plastic, so as to fit over a particular rear-view mirror.

The security bracket and second shell can be colored to match the color of the shell or it can be a different color to accent the vehicle.

As it will be appreciated by one skilled in the art, the exterior dimensions of rear view mirrors vary from vehicle to vehicle and it has been found that, by stamping the bracket and the security insert out of sheet metal, it is very easy to revise the shape of the security bracket to meet the various shapes of the rear view mirrors employed on vehicles. This is also true for the second shell as illustrated in FIGS. 15 and 16.

The security bracket is formed in a conventional manner using conventional equipment. It can be stamped or cut out of sheet metal and subsequently bent to fit inside the shell. It can be formed form one piece with deep bending without having to cut it out of sheet metal. It can be formed in any conventional process, in either a conventional cold metal or hot metal process. It can also be molded form plastic and formed as a single molded piece rather than formed from metal.

It will be understood that the claims are intended to cover all changes and modifications of the preferred embodiment of the Invention herein chosen for the purposes of illustration which should not constitute departure from the spirit and scope of the Invention. The preferred embodiments are not intended to limit but merely to illustrate the Invention and the claims are intended to cover the broad concept not merely that which is disclosed in the preferred embodiments.

What is claimed:

1. An anti-theft device for a mirror plate of an externally mounted rear view vehicular mirror wherein said rear view mirror has a shell in which said mirror plate is mounted, said device comprising a lip affixed to said shell, said lip overlapping and substantially surrounds the edge of the mirror plate.

2. The device of claim 1 wherein the overlap is 1 to 3 milimeters.

3. The device of claim 1 wherein said lip is a Portion of a security bracket and said security bracket is affixed to said shell.

4. The device of claim 1 wherein said lip is a portion of a second shell which fits over said shell of said rear-view mirror and is affixed to said shell.

5. The device of claim 1 wherein said lip is a portion of said shell of said rear-view mirror

6. The device of claim 3 further comprising a security insert which is affixed inside said mirror shell and to which is secured to the security bracket by a fastener.

7. The device of claim 3 wherein the security bracket has wings which extend out and over the shell and by which the security bracket is affixed to the shell by a fastener.

8. The device of claim 3 wherein the security bracket is made of sheet metal.

9. The device of claim 3 wherein the security bracket is colored to match the color of the shell.

10. The device of claim 3 wherein said shell and said security bracket have bee pre formed to have an interlocking tongue and groove arrangement which allows the security bracket to be affixed to said shell.

11. The device of claim 6 wherein a rubber housing fits between said security insert and said security bracket and extends over said fastener to cover said fastener.

12. The device of claim 7 wherein a rubber housing fits between said shell and said security bracket extends over said fastener to cover said fastener.

13. The device of claim 12 wherein rubber housing is colored to match the color of the shell.
